(19) United States
(12) Patent Application Publication
(10) Pub. No.: US 2009/0025574 A1
(43) Pub. Date: Jan. 29, 2009

(54) COOKING APPARATUS AND METHODS OF USE

(76) Inventors: Terrence P. Byrnes, Mound, MN (US); Raymond T. Gunderson, North Oakdale, MN (US); Carlos E. Rodriguez, Woodbury, MN (US)

Correspondence Address: MOORE & HANSEN, PLLP, 225 SOUTH SIXTH ST, MINNEAPOLIS, MN, 55402, US

(21) Appl. No.: 11/829,517

(22) Filed: Jul. 27, 2007

(51) Int. Cl. A47J 37/07

(52) U.S. Cl. 99/447; 126/25 R; 126/26; 426/523; 99/324

(57) ABSTRACT

Outdoor cooking apparatus including a basin, a grate within the basin, a pedestal including a housing having a chamber and a container for a heat generating source. The container is preferably an insertable starter unit that is removably secured within the chamber and remains in place during cooking. The outdoor cooking apparatus is particularly useful for wok cooking as a wok may be placed on the grate such that a small diameter of very hot air is delivered from the insertable starter unit to the wok. The outdoor cooking apparatus may further be modified for other cooking purposes requiring a broader diameter of lower heat. This embodiment further includes a diffuser, preferably including a plate having apertures therein and a second larger planar grate placed within the basin above the diffuser.

### FIELD OF THE INVENTION

The disclosure relates generally to a cooking apparatus for food preparation and structural elements thereof. More particularly, the disclosure relates to an outdoor cooking apparatus including a basin interconnected to a pedestal having a housing and a container for a heat generating source such as an insertable starter unit that is insertable within the housing.

### BACKGROUND

One known outdoor cooking apparatus is a charcoal grill. Charcoal grills use charcoal briquettes as their fuel source. The briquettes, when burned, transform into embers that radiate the heat necessary to cook food. The typical charcoal grill is a hollow, metal hemisphere with three legs and a small metal disc to catch ash, with a lower grate to hold the charcoal and an upper grate to hold the food to be cooked.

Often, to light the charcoal, a chimney starter, also known as a charcoal chimney is used. A chimney starter usually includes a steel cylinder about 8 inches in diameter and about 12 to 18 inches tall. Chimney starters commonly have a plate or grate with several holes that are welded horizontally inside the cylinder about 3 inches from the bottom. The chimney of the chimney starter may have large apertures drilled around its circumference below the grate. This is to allow air to flow up underneath the charcoal, which rests on top of the grate. Chimney starters also have handles that are frequently insulated.

The chimney starter may be used by first placing newspaper in the chimney (or alternatively, below the grate in a second chamber). Second, charcoal is placed within the chimney and then the newspaper is ignited through the starter grate (or alternatively, the holes). This fire, which is easy to start, eventually will ignite the charcoal. Once the top layer of briquettes is fully lit (when they have a light coating of gray ash), the chimney starter is lifted by the handle, the cooking grill surface is removed and the briquettes are poured into the basin of the barbeque grill. Then, the chimney starter is set aside. A chimney starter is commonly used in situations where the use of charcoal lighter fluid, a toxic petroleum derivative, is either banned or deemed to be undesirable.

Wok pans, by design, are meant to be used over a gas stove which has either concentrically sloped grates or burners that are recessed below a round “pit” in order to encompass the wok's shape. Sloped grates on a stove further provide stability to the curved wok. A recessed “pit” stove provides not only stability for the wok, it also concentrates heat by directing all the hot gases produced onto the wok instead of allowing such hot gases to escape around the wok. This allows foods to be stir-fried at a very desirable high temperature. Using gas stoves for wok cooking has many drawbacks because the grills are typically located indoors and cost hundreds of dollars. Wok cooking also produces a great deal of smoke which is highly undesirable indoors sufficient ventilation to clear the smoke is often unavailable. It is believed that the concentrated smoke billowing from improperly ventilated super-hot cooking oils, especially unrefined cooking oils, contributes to eye irritation, respiratory problems or potentially other, more serious health concerns. Therefore, others have tried to use a wok outside on a traditional charcoal or gas grill. This method has proved ineffective as not enough heat is concentrated in a small enough diameter, to provide enough heat for effective cooking in a wok, especially if there is even a little wind.

Therefore, what is needed is an outdoor cooking apparatus that generates concentrated heat for wok cooking and the like. What is also needed is an economical, adaptable apparatus that may be used both for cooking that requires high levels of concentrated heat and for traditional barbeque cooking that requires a lower, less concentrated heat.

The present invention provides solutions for these and other problems associated with the prior art devices for outdoor cooking and methods used to accomplish the same.

### SUMMARY OF THE DISCLOSURE

The present invention provides an outdoor cooking apparatus having a basin interconnected to a pedestal and these two structural elements of the cooking apparatus. In preferred embodiments, the basin includes a sidewall and a bottom having a bottom aperture. The pedestal has a housing positioned below the bottom aperture. The housing includes first and second ends and a middle portion having an opening. In preferred embodiments, the pedestal will include a generally cylindrical housing and a base connected to the second end configured and arranged to support the housing in an upright position. The housing of the pedestal preferably defines a chamber. In preferred embodiments, the outdoor cooking apparatus further includes a container for a heat generating source, most preferably an insertable starter unit, that is positioned, preferably removably secured, within the chamber so that heat, generated by combustible material located within the chamber, can be concentrated proximate the bottom aperture.

In order to prepare the outdoor cooking apparatus of the present invention for cooking, the insertable starter unit is removed from the housing. Then, material, such as charcoal, is placed within the insertable starter unit. Another easily ignitable material capable of relatively rapid combustion, such as paper, may also be placed within the insertable starter unit to promote combustion of the charcoal. In one possible method, the insertable starter unit is placed within the outdoor cooking apparatus, and the paper is ignited. The insertable starter unit remains in the outdoor cooking apparatus during cooking, serving as the heat source. A wok, cooking pan or surface is placed within the basin, preferably on a small grate having a stand, such that heat is delivered from the removable insertable starter unit to the wok.

The insertable starter unit defines a chimney having a first section and a second section divided by a grate. The combustible material and the easily ignitable material can be introduced into the first section. The outdoor cooking apparatus also includes a basin mounted proximate a first end of the housing. The basin is arranged with the chamber such that during combustion of the combustible material, a strong channel of hot air rises up the chamber and is delivered through the bottom aperture.

Alternatively, the preferred outdoor cooking apparatus is modifiable such that the hot air produced by the combustible material may be diffused to accommodate cooking requiring lower temperatures over larger diameters. In this alternative embodiment, the outdoor cooking apparatus further incorporates a diffuser used to disperse the strong channel of hot air rising from the insertable starter unit when it contains a sufficient quality of burning combustible material. The preferred diffuser includes a plate having a series of apertures. The apertures are arranged on the plate such that they allow some hot air to pass and block or redirect the rest. Preferably, the center of the plate is free of apertures to block the channel of hot air where it is the strongest. The diffuser is preferably used in conjunction with the small grate. In this embodiment, the diffuser is placed on top of the small grate with the stand facing downward, preferably in the center. The diffuser preferably further includes a lip to direct hot air towards the basin sidewall and legs to secure the diffuser on the small grate. The food to be cooked can then be placed on a large grate that is positioned towards the top of the basin. This embodiment has cooking properties similar to a typical charcoal grill.

Additional objects, advantages, and features will become apparent from the following description and the claims that follow, considered in conjunction with the accompanying drawings.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown, but otherwise include corresponding parts;

FIG. 1 is a plan view of an outdoor cooking apparatus 10 of the present invention, the cooking apparatus including a basin 40 interconnected with a pedestal 11, wherein the pedestal 11 includes a housing 12 having a chamber 22;

FIG. 2 is a partial, cross-sectional view of the outdoor cooking apparatus 10 of FIG. 1 as seen from the line 2-2 of FIG. 1 illustrating the placement of an insertable starter unit 70 and an ash pan 90;

FIG. 3 is a cross-sectional view of the outdoor cooking apparatus 10 of FIG. 1 as seen from line 3-3 of FIG. 1 showing the insertable starter unit 70 positioned within the chamber 22;

FIG. 4 is a partial, cutaway view of the outdoor cooking apparatus 10 shown in FIG. 1 the present invention illustrating a channel of hot air generated by combustible material 38 ignited within the insertable starter unit 70;

FIG. 5 is a partial, cutaway view of the basin 40 of a modified cooking apparatus 10′ similar to that of FIG. 1 showing a small grate 60 and a diffuser 100 positioned to diffuse the hot air emanating from the pedestal 11;

FIG. 6 is a partial, exploded view of the modified cooking apparatus 10′ of FIG. 5;

FIG. 7 is a partial, exploded perspective view of the pedestal 11f the cooking apparatus 10 of FIG. 1 showing where the insertable starter unit 70 and ash pan 90 are inserted within the chamber 22;

FIG. 8 is a perspective view of the ash pan 90 of FIG. 7, shown partially in phantom, within the chamber 22;

FIG. 9 is a perspective view of the insertable starter unit 70 of FIG. 7, shown partially in phantom, being inserted into the chamber 22 in a first position; wherein the ash pan 90 is already in place within the chamber 22; and

FIG. 10 is a perspective view illustrating the insertable starter unit 70 of FIG. 7, shown partially in phantom, in a second position and in a fourth, secured position.

### DETAILED DESCRIPTION OF PREFERRED EMBODIMENTS

The following description of various embodiments implemented in the context of wok cooking is to be construed by way of illustration rather than limitation. This description is not intended to limit the invention or its applications or uses. For example, while various embodiments are described as being implemented in this context, it will be appreciated that the principles of the disclosure are applicable to cooking apparatuses operable in other applications, such as grilling.

In the following description, numerous specific details are set forth in order to provide a thorough understanding of various embodiments. It will be apparent to one skilled in the art that some embodiments may be practiced without some or all of these specific details. In other instances, well known components and process steps have not been described in detail. These various embodiments include preferred embodiments of the present invention.

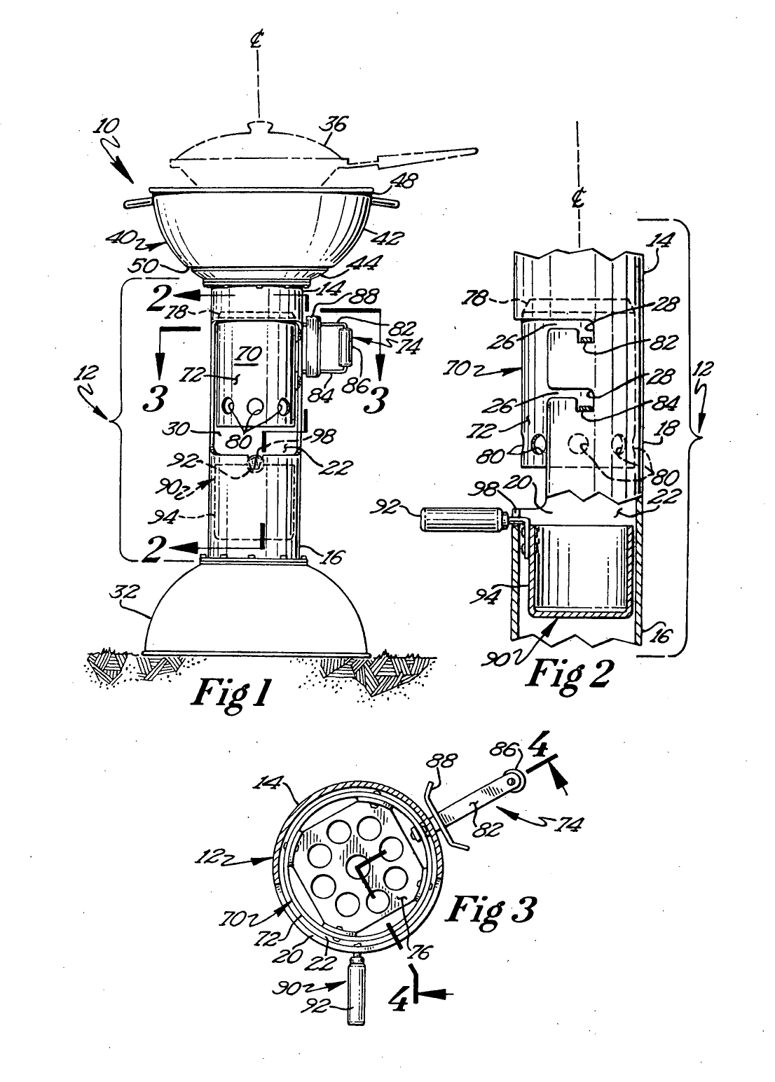

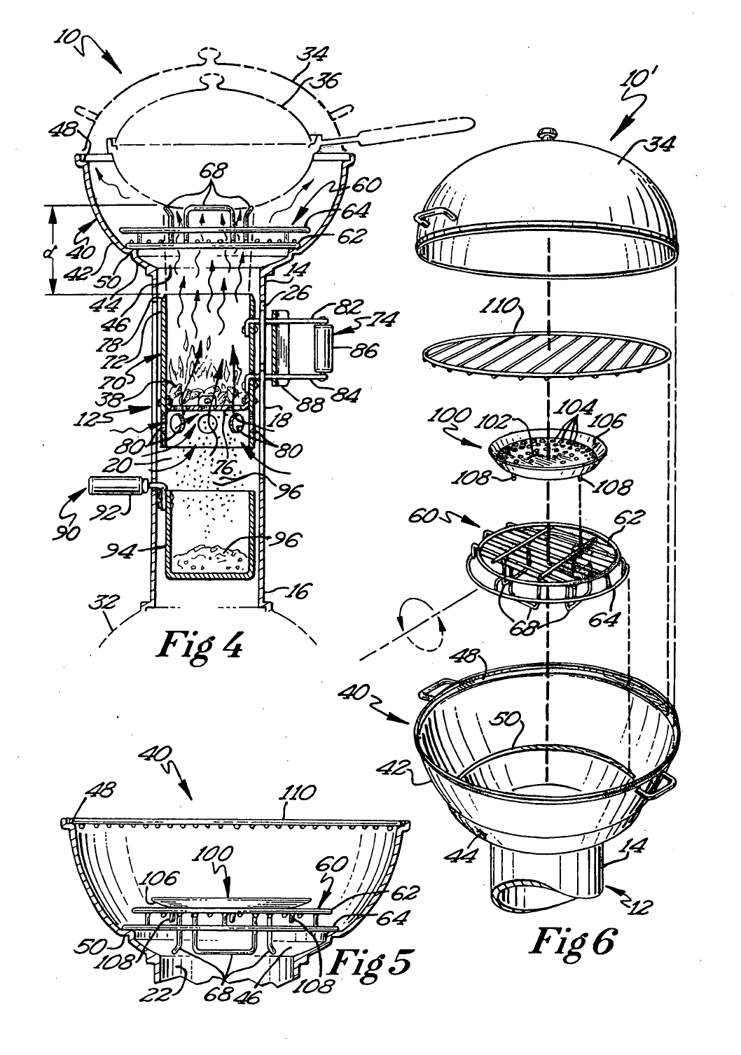

Referring now to the drawings, in particular, FIGS. 1-4 depict an outdoor cooking apparatus 10 of the present invention including a pedestal 11 having a base 32 and housing 12 with a generally hollow chamber 22. The housing 12 further has a first end 14, a second end 16 and a middle portion 18. The first end 14 is interconnected to a basin 40. The basin 40 has a side wall 42, a bottom 44 and a bottom aperture 46 (see, FIG. 4). The bottom 44 is connected to the pedestal 11 such that hot air may pass from the chamber 22 to the basin 40 in a concentrated channel-like fashion (see, in particular, FIG. 4). The basin 40 preferably includes a first ridge 48 and a second ridge 50. The first ridge 48 is located along the basin sidewall 42 towards the top. The second ridge 50 is located near the basin bottom 44 and is sized and configured to retain a small grate 60. The preferred small grate 60 has a grate top 62 and a ring 64, which are interconnected by a plurality of connectors 66. Preferably, the grate top 62 is a grid such that hot air may easily pass through the small grate 60. Extending from the grate top 62 is a stand 70 that is configured and arranged to support a wok 36 or other cooking pan without substantially blocking the channel of hot air rising from the bottom aperture 46 (as depicted in dashed lines through the bottom aperture 46 of FIG. 4).

The middle portion 18 of the housing 12 has an opening 20 such that it may receive a container 70 for a heat generating source such as charcoal or the like. In the most preferred embodiments, the container 70 is an insertable starter unit which is similar to known chimney starters. The insertable starter unit 70 includes a chimney 72, handle 74 and starter grate 76. The chimney 72 has a only slightly smaller diameter than the diameter of the chamber 22 such that the heat generated from combustible material 38 is directed generally straight up through the chamber 22. Dividing the chimney 72 into a first section and a second section 71a, 71b is the starter grate 76, which is arranged and configured to retain the combustible material 38 (see FIG. 4) within the chimney 72 while allowing air to be drawn from the section of the chimney 72 below the starter grate 76. The second section 71b includes a series of apertures 80 that provide an area where the burning combustible material 38 may draw in air from outside the insertable starter unit 70.

The handle 74 of the insertable starter unit 70 has a first portion 82 and a second portion 84 interconnected by a connecting portion 86. The connecting portion 86 is preferably made of a heat insulating material because the connecting portion 86 serves as a grip for holding the insertable starter unit 70. It is further desirable that the handle 74 include a heat guard. The heat guard 88 is preferably bowed to have a slight curvature away from the chimney 72. The slight curvature aids in keeping the connecting portion 86 cool by deflecting heat radiating from the chamber 22.

As air is essential in keeping the combustible material 38 lit and hot, it is preferable that the housing 12 be configured such that when the insertable starter unit 70 and the ash pan 90 are placed within the chamber 22, the opening 20 be only partially unobstructed. As well as providing access to the necessary oxygen for combustion, the draft of air created by the combustible material 38 pulling in air also minimizes the risk of hot ash 98 falling out of the housing 12.

In order to generate a hot “channel” of heat directed at the bottom of a cooking pan, such as a wok pan, the distance “d” between the insertable starter unit and the cooking pan (or grate stand since the cooking pan typically is resting on the stand) is preferably from about 2 to about 20 inches, more preferably about 4.25 inches.

To prepare the outdoor cooking apparatus 10 of the present invention for wok cooking and the like, the small grate 60 is inserted into the basin 40 so that the grate top 62 is resting on the second ridge 50 of the basin 40 and the stands 68 are facing upward. The cooking pan or wok 36 can then be positioned and supported on the stands 68 of the small grate 60 during the cooking process. The small grate 60 may have numerous other configurations to support different types of pans or create different surfaces for other types of cooking that require the same channel-like distribution of high heat. The location of the small grate 60 and the second ridge 50 are preferably close to the bottom 44 of the basin 40 such that the channel of hot air emerging from the chamber 22 will be focused on the bottom of the wok 36.

To begin the heat generating process, the insertable starter unit 70 may be prepped by inserting an easily ignitable material (not shown), such as paper, most preferably newspaper, into the chimney 72 and loosely on the grate 78. Then combustible material 38, such as charcoal, is placed on top of the easily ignitable material. Next, the insertable starter unit 70 is secured in the chamber 22 as discussed in detail below. Then the easily ignitable material is lit with a match, candle lighter, or similar apparatus by reaching into the air intake section 20 and igniting the easily ignitable material through the starter grate 76. Then, the easily ignitable material will burn and the combustible material 38 should eventually light.

Alternatively, the combustible material 38 may be ignited while the insertable starter unit 70 is outside of the chamber 22. The combustible material 38 inside the insertable starter unit 70 is lit just as mentioned above, but before the insertable starter unit is placed within the chamber 22. Once the combustible material 38 is ignited, the insertable starter unit 70 is carefully secured within the chamber 22 as will be discussed in detail below. This method may have safety drawbacks as it requires moving the insertable starter unit while it contains burning material.

As depicted in FIGS. 5-6, the outdoor cooking apparatus 10′ (partially shown) of the present invention may be modified to cook foods that require a lower temperature over a broader diameter. In this alternate embodiment, the small grate 60 is inverted such that the stands 68 are facing downward. Then, the small grate 60 is inserted into the basin 40 such that it rests on the second ridge of the basin 50. Next, a diffuser 100 is placed on the small grate 60 such that the legs 108 of the diffuser 100 protrude through the grate top 62. The diffuser 100 includes a plate 102 having a series of apertures 104, preferably around the edge, to enhance the dispersing effect of the diffuser 100 on the channel of hot air rising from the bottom aperture 46 (see also FIG. 4). The apertures 104 allow some hot air to pass and the plate 102 blocks some of the hot air coming from the chamber 22 or pushes it to the outside of the diffuser 100 with a lip 106. The preferred diffuser 100 further includes legs 108 that aid in securing the diffuser 100 in position while on the small grate 60. Once the diffuser 100 is set in place within the basin 40, a large grate 110 is positioned on the first ridge 48 towards the top of the basin 40 which serves as a cooking surface or support for pans, grill baskets and the like. This embodiment has cooking properties similar to that of a traditional charcoal grill.

FIG. 7 shows the insertable starter unit 70 and the ash pan 90 illustrating their placement within the pedestal 12 in an exploded view. Preferably, the insertable starter unit 70 has a tapered edge 78 to aid in the insertion of the insertable starter unit 70 in the chamber 22. In preferred embodiments, the ash pan 90 has a handle 92 connected to a container 94. The preferred placement of the ash plan 90 within the pedestal 12 is best shown in FIG. 8. The ash pan container 94 is inserted into the middle portion 18 of the pedestal 12 towards the second end 18 to collect falling ash 98 from the burning combustible material 38. While the ash pan 90 is inserted, the handle 92 remains outside of the pedestal chamber 22. Preferably, the pedestal 12 will include a recess 98 in which the handle 92 may be placed to secure the ash pan 90 within the pedestal 12. In operation of the outdoor cooking apparatus 10 (see also FIG. 1), the ash pan 90 is preferably inserted before the insertable starter unit 70 and removed once the insertable starter unit 70 has been removed from the cooking apparatus 10. After cooking, the hot ash in the pan may be cooled and properly disposed.

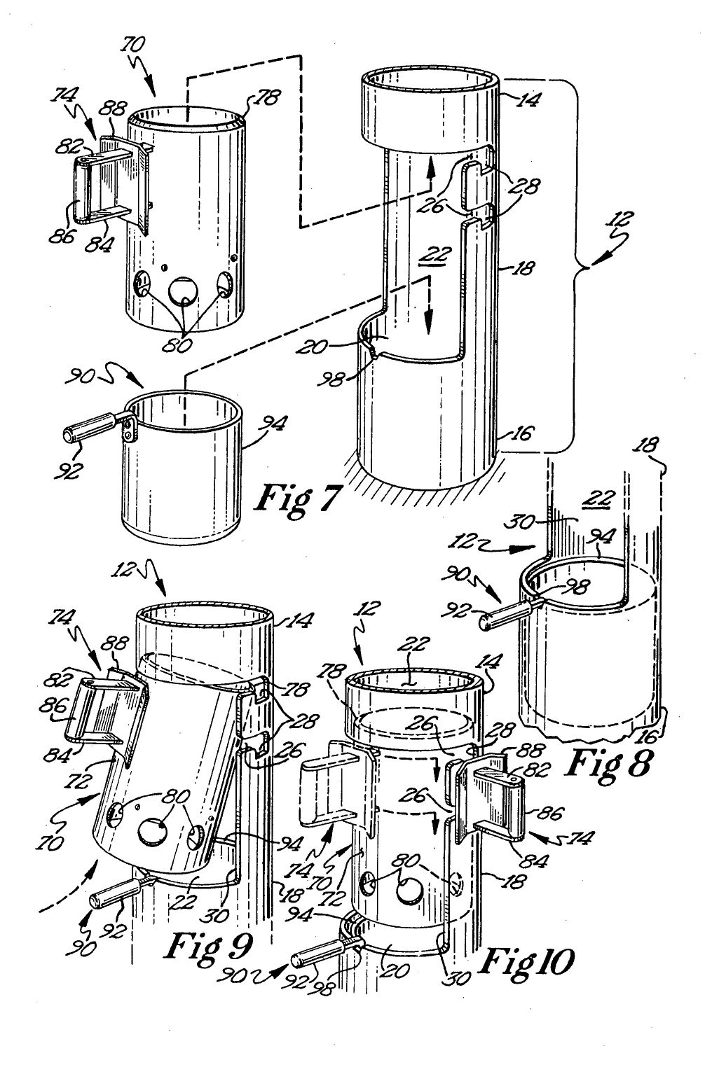

Now also referring to FIGS. 9-10, which illustrate the preferred method of securing the insertable starter unit 70 within the pedestal 12. First, as shown in FIG. 9, the user must first introduce the insertable starter unit 70 into the chamber 22 via the opening 20 (the “first position”). In preferred embodiments, once the insertable starter unit 70 is introduced into the chamber 22, the insertable starter unit 70 is raised within the chamber 22 such that the handle 74 is aligned with generally horizontal slots 26 of the pedestal 12 (the “second position”). Then the insertable starter unit 70 is rotated such that the first portion and second portion 82, 84 of the handle 74 are inserted into the horizontal slots 26 (the “third position”). In the most preferred embodiment, the pedestal will further comprise a securing device so that the insertable starter unit may be removably secured within the chamber. For example, the securing device may include generally vertical slots 28 in the pedestal 12 that stem down from the horizontal slots 26. In this embodiment, the insertable starter unit 70 may further be lowered into a fourth position such that the first and second portions 82, 84 are secured into the vertical slots 28 as best shown in FIG. 10. This fourth position functions as a secured position such that if the outdoor cooking apparatus 10, 10′ (see FIGS. 1 and 6) is bumped, the insertable starter unit 70 will not fall out of the cooking apparatus thereby reducing a safety hazard.

It will be understood by those who practice the embodiments described herein and those skilled in the art that various modifications and improvements may be made without departing from the spirit and scope of the disclosed embodiments. The scope of protection afforded is to be determined solely by the claims and by the breadth of interpretation allowed by law.

What is claimed is:

1. A cooking apparatus comprising:
a basin including a sidewall and a bottom having a bottom aperture;
a pedestal including a housing having a first end, a second end and a middle portion in between the ends, the middle portion having an opening; the housing having a chamber accessible via the opening; wherein the first end is interconnected to the basin such that the bottom aperture is aligned with the chamber; and
a container for a heat generating source; wherein the opening is sized and configured to receive the heat generating source such that it can be retained within the chamber; wherein the container is arranged and configured to remain within the housing during cooking.

2. The cooking apparatus of claim 1, wherein the container is an insertable starter unit including a chimney; wherein the chamber is sized and configured to receive the insertable starter unit via the opening.

3. The cooking apparatus of claim 2, wherein the chimney includes a starter grate that divides the chimney into a first section and a second section.

4. The cooking apparatus of claim 3, further comprising ventilation apertures within the second section of the chimney.

5. The cooking apparatus of claim 2, wherein when the insertable starter unit is placed within the chamber, a portion of the opening is unobstructed by the insertable starter unit.

6. The cooking apparatus of claim 2, wherein the insertable starter unit further includes a handle.

7. The cooking apparatus of claim 6, wherein the insertable starter unit can be removably secured within the chamber.

8. The cooking apparatus of claim 7, wherein the middle portion includes at least one generally horizontal slot stemming from the opening; wherein each generally horizontal slot is sized to receive part of the handle of the insertable starter unit to removably secure the insertable starter unit within the chamber.

9. The cooking apparatus of claim 8, wherein the middle portion further includes a generally vertical slot stemming downward from each generally horizontal slot sized to receive part of the handle of the insertable starter unit.

10. The cooking apparatus of claim 1, further comprising a first grate placed within the basin; wherein the first grate has an upwardly extending stand that is arranged and configured to support a cooking pan above the bottom aperture.

11. The cooking apparatus of claim 10, wherein the first grate is placed proximate the bottom of the basin.

12. The cooking apparatus of claim 1, further comprising a diffuser configured and arranged to disperse hot air rising from the bottom aperture.

13. The cooking apparatus of claim 12, wherein the diffuser includes plate having an edge and a plurality of apertures.

14. The cooking apparatus of claim 13, wherein the diffuser further includes an upwardly extending lip located around the edge.

15. A method of cooking with an outdoor cooking apparatus; the method comprising the steps of:
providing a cooking apparatus, the cooking apparatus including a basin interconnected to a pedestal, the pedestal having a housing, the housing having a first end, a second end and a middle portion in between the ends, the middle potion having an opening and a generally hollow chamber accessible via the opening, the basin including an interior and a bottom aperture, the housing interconnected with the pedestal such that the basin interior is in communication with the hollow chamber; the cooking apparatus further including a heat generating source; and
introducing the heat generating source into the chamber via the opening so that heat generated by the heat generating source can be concentrated in the interior of the basin proximate the bottom aperture.

16. The method of cooking with an outdoor cooking apparatus of claim 15, wherein the heat generating source is contained within an insertable starter unit having a chimney and a combustible material inside the chimney.

17. The method of preparing a cooking apparatus for cooking of claim 16, further comprising the step of removably securing the insertable starter unit within the chamber.

18. The method of preparing a cooking apparatus for cooking of claim 17, wherein the insertable starter unit includes a handle; wherein the housing has a generally horizontal slot sized and configured to receive part of the handle; wherein the method of securing the insertable starter unit includes lifting the insertable starter unit such that the handle is aligned with the generally horizontal slot and rotating the insertable starter unit such that part the handle slides into the generally horizontal slot.

19. The method of preparing a cooking apparatus for cooking of claim 18; wherein the housing further includes a generally vertical slot stemming downward from the generally horizontal slot; the method further comprising the step of lowering the insertable starter unit such that part of the handle is removably secured within the generally vertical slot.

20. The method of preparing a cooking apparatus for cooking of claim 18, wherein the handle has two portions interconnected by a connecting portion and the housing has two generally horizontal slots sized and configured to receive and removably secure the two portions of the handle.

21. The method of preparing a cooking apparatus for cooking of claim 15, further comprising the steps of:
providing a diffuser; and
placing the diffuser such that heat rising from the chamber is dispersed as it contacts the diffuser;
inserting a second grate within the basin and above the first grate.

22. A method of preparing a cooking apparatus for use; the method comprising the steps of:
providing a cooking apparatus including a pedestal having a housing, the housing having a first end, a second end and a middle portion in between the ends, the middle portion having an opening and a generally hollow chamber accessible via the opening; the cooking apparatus further including an insertable starter unit having chimney and a handle; and
introducing the insertable starter unit into the chamber via the opening in a first position such that the insertable starter unit is substantially contained within the chamber.

23. The method of claim 22, wherein the opening has a generally horizontal slot; the method further comprising the step of lifting the insertable starter unit in the chamber via the opening into a second position such that the handle of the insertable starter unit is aligned with the generally horizontal slot.

24. The method of claim 23, further comprising the step of rotating the insertable starter unit into a third position such that handle is received by the generally horizontal slot.

25. The method of preparing a cooking apparatus for use of claim 24, wherein the step of providing further includes providing a combustible material and placing it within the insertable starter unit and the method further comprises the step of igniting the combustible material after the insertable starter unit is in the chamber in the third position.

26. The method of preparing a cooking apparatus for use of claim 24, further comprising the step of removably securing the insertable starter unit within the chamber.

27. The method of preparing a cooking apparatus for use of claim 26, wherein the pedestal further contains at least one generally vertical slot stemming down from the generally horizontal slot and the step of removably securing includes lowering the insertable starter unit into a fourth position after the insertable starter unit is rotated into the third position; wherein the fourth position removably secures the insertable start unit within the chamber.

28. An outdoor cooking apparatus kit comprising:
a pedestal including a housing having a first end, a second end, a middle portion having an opening and a chamber accessible via the opening;
an insertable starter unit including a chimney having a starter grate dividing the chimney into a first portion and a second portion; wherein the housing chamber is sized and configured to receive the insertable starter unit via the opening; the insertable starter unit further including a handle connected to the chimney; and
a basin having a bottom and a side wall; wherein the bottom includes a bottom aperture; wherein the first end of the housing can be interconnected to the basin such that the aperture of the basin bottom is aligned with the chamber.

29. The kit of claim 28, further comprising a cooking pan.

30. The kit of claim 28, further comprising an ash pan.

31. The kit of claim 28, further comprising a grate.

32. The kit of claim 31, wherein the grate has at least one upwardly extending stand capable of supporting the cooking pan above the bottom aperture without significantly blocking the basin bottom aperture.

33. The kit of claim 28, further comprising a diffuser; wherein the diffuser is configured and arranged to disperse hot air rising from the chamber when the diffuser is inserted into the basin.

34. The kit of claim 33, wherein the diffuser includes a plate having a plurality of apertures.

35. The kit of claim 28, further comprising a basin cover.

36. The kit of claim 28, wherein the pedestal includes a base that can be connected to the second end to support the housing in an upright position.
